(19) United States
(12) Patent Application Publication
(10) Pub. No.: US 2013/0308079 A1
(43) Pub. Date: Nov. 21, 2013

(54) Method for Manufacturing LCD Panel and Liquid Crystal Glass

(71) Applicant: Chenghung Chen, Shenzhen (CN)

(72) Inventor: Chenghung Chen, Shenzhen (CN)

(21) Appl. No.: 13/520,209

(22) PCT Filed: May 23, 2012
(86) PCT No.: PCT/CN12/75952

§ 371 Date: Jul. 2, 2012

(30) Foreign Application Priority Data
May 16, 2012 (CN) 201210151906.4

(51) Int. Cl. G02F 1/1335

(52) U.S. Cl. 349/106; 445/25

(57) ABSTRACT

The invention provides a method for manufacturing an LCD panel and liquid crystal glass, comprising the steps: A: A bulge is formed in the position of a color filter substrate corresponding to an array substrate pad; B: A conducting layer is formed on the color filter substrate, and the conducting layer covers the bulge; C: The color filter substrate and the array substrate are pressed to make the conducting layer come into contact with the pad; D: The UV is used for curing the sealant. In the invention, because the bulge is formed in the position of the color filter substrate corresponding to the array substrate pad in the method for manufacturing the LCD panel, and the bulge is provided with the conducting layer, the color filter substrate and the array substrate are conducted and have the same potential; when the liquid crystal molecules at the edge of the LCD panel are irradiated by the UV, the liquid crystal molecules at the edge of the LCD panel will not tilt in advance; thus, the display effect at the edge of the LCD panel is uniform, and the effective active area of the LCD panel is expanded, so that the narrowing of the LCD device is more easy to be realized.

### TECHNICAL FIELD

The invention relates to the field of liquid crystal displays (LCDs), and more particularly to a method for manufacturing an LCD panel and liquid crystal glass.

### BACKGROUND

In a manufacturing process of PSVA (Polymer Stabilized Vertical Alignment) of an LCD device, a monomer sensitive to light rays shall be added in liquid crystal or on the surface of an alignment layer (PI) so as to form a polymer for auxiliary alignment in a reaction in subsequent PSVA manufacturing processes; as shown in FIG. 1, when ultraviolet (UV) is used for irradiating a sealant 15 in an SUV (the sealant is cured by using UV) manufacturing process prior to the PSVA manufacturing process, an ultraviolet mask (UV mask) 7 shall be used for blocking the irradiation of the UV to prevent liquid crystal molecules 8 of an active area/AA area from reacting in advance caused by being irradiated by UV before the PSVA manufacturing process (i.e. pre-cured action); because the function of oblique light, the manufacture or counterpoint accuracy of the UV mask 7, etc., must be considered, the boundary of the active area/AA area must be designed to be away from the boundary of the UV mask 7 for a distance; otherwise, an liquid crystal pre-tilt is different from most of the liquid crystal molecules of active area/AA area because the monomer reacts in advance around the active area/AA area; the phenomenon of an nonuniform picture occurs around the active area/AA area 9 around mura); as shown in FIG. 2, the liquid crystal molecules in a dotted frame are tilted in advance due to the function of the UV, resulting in that vertical alignment cannot be formed in the subsequent PSVA manufacturing processes; thus, the picture at the periphery of the LCD panel is nonuniform, and the narrowing of the LCD device is also affected.

### SUMMARY

In view of the above-described problems, the aim of the invention is to provide a method for manufacturing an LCD panel and liquid crystal glass capable of enhancing the display effect of the LCD device and enlarging the active area of the LCD panel.

The aim of the invention is achieved by the following technical scheme: 1. A method for manufacturing an LCD panel comprises the steps:

A: When a color photoresist material layer is formed on a color filter substrate, a bulge is formed by forming a red color photoresist material layer, a green color photoresist material layer and a blue color photoresist material layer which are stacked in the position of the color filter substrate corresponding to an array substrate pad;

B: A conducting layer is formed on the color filter substrate, and the conducting layer covers the bulge;

C: The color filter substrate and the array substrate are pressed to make the conducting layer come into contact with the pad;

D: The UV is used for curing the sealant.

The aim of the invention can further be achieved by the following technical scheme: A method for manufacturing an LCD panel comprises the steps:

A: The bulge is formed in the position of the color filter substrate corresponding to the array substrate pad;

B: A conducting layer is formed on the color filter substrate, and the conducting layer covers the bulge;

C: The color filter substrate and the array substrate are pressed to make the conducting layer come into contact with the pad;

D: The UV is used for curing the sealant.

Preferably, in the step A, the bulge formed on the color filter substrate is formed by forming the stacked color photoresist material layers in the position of the color filter substrate corresponding to the pad in the step of forming the color resistance on the color filter substrate. The bulge is formed by forming the stacked color photoresist material layers in the step of forming the color resistance on the color filter substrate; thus, no additional new processing step is added to form the bulge.

Preferably, in the step A, the stacked color photoresist material layers formed on the color filter substrate are formed by forming two color photoresist material layers in the position of the color filter substrate corresponding to the array substrate pad. The bulge can be formed by stacking the two color photoresist material layers according to the thickness of the color photoresist materials and the thickness of the conducting layer.

Preferably, the two color photoresist material layers are respectively the red color photoresist material layer and the green color photoresist material layer; or the two color photoresist material layers are respectively the red color photoresist material layer and the blue color photoresist material layer; or the two color photoresist material layers are respectively the green color photoresist material layer and the blue color photoresist material layer. Corresponding combination of color photoresist material layers can be selected according to sequential technologies for forming the color photoresist material layers, so as to facilitate the formation of the color resistance and the bulge.

Preferably, in the step A, the stacked color photoresist material layers formed on the color filter substrate are formed by forming three color photoresist material layers in the position of the color filter substrate corresponding to the array substrate pad. The bulge can also be formed by stacking the three color photoresist material layers according to the thicknesses of different LCD panels.

Preferably, the three color photoresist material layers are respectively the red color photoresist material layer, the green color photoresist material layer and the blue color photoresist material layer. The stacked bulge is formed by using the color photoresist material layers of three primary colors; thus, no additional processing step is added.

Preferably, in the step B, the conducting layer is an ITO material layer. The ITO material is transparent, and does not affect the light transmittance of the LCD panel.

Preferably, in the step A, the bulge formed on the color filter substrate is formed by forming a stacked black matrix material layer and the color photoresist material layers in the position of the color filter substrate corresponding to the pad in the step of forming the color resistance and a black matrix on the color filter substrate. The bulge can also be formed by stacking the three color photoresist material layers according to the manufacturing technology of the material layers on the LCD panel.

Liquid crystal glass comprises an upper substrate and a lower substrate; the lower substrate comprises a plurality of array substrate units; the upper substrate comprises a plurality of color filter substrate units which correspond to the array substrate units; each array substrate unit on the lower substrate is provided with a pad at the edge; a bulge is arranged in the position of the color filter substrate units corresponding to the pad, the color filter substrate units are provided with a conducting layer, and the conducting layer covers the bulge; the conducting layer on the bulge comes into contact with the pad.

In the invention, because the bulge is formed in the position of the color filter substrate corresponding to the array substrate pad in the method for manufacturing the LCD panel, and the bulge is provided with the conducting layer, the color filter substrate and the array substrate are conducted to have the same potential in the step of curing the sealant by using the UV; thus, a pre-tilt will not be formed because the phenomenon that the irradiated liquid crystal molecules under UV irradiation tilts in advance is avoided; the phenomenon that the picture at the edge is nonuniform due to the pre-tilt of the liquid crystal molecules is also avoided at the edge of the LCD panel; that is to say, when the liquid crystal molecules at the edge of the LCD panel are irradiated by the UV, the liquid crystal molecules at the edge of the LCD panel will not tilt in advance; thus, the display effect at the edge of the LCD panel is uniform; the range of the AA area is further expanded, namely the effective active area of the LCD panel is expanded, so that the narrowing of the LCD device can be realized more easily.

### BRIEF DESCRIPTION OF FIGURES

FIG. 1 is a schematic diagram of a sealant curing processing step of a conventional LCD panel;

FIG. 2 is a schematic diagram that peripheral liquid crystal molecules form pre-tilts after a frame curing process of a conventional LCD panel;

FIG. 3 is a structural diagram of the edge of an LCD panel in a frame curing step of a conventional LCD panel;

FIG. 4 is a structural diagram of an exposed pad after cutting the edge of a color filter substrate in a circuit test prior to a PSVA manufacturing process;

FIG. 5 is a schematic diagram of an exposed pad on the periphery of an LCD panel;

FIG. 6 is a structural diagram of the edge of an LCD panel in a frame curing step of an example of the invention;

FIG. 7 is a schematic diagram of a sealant curing step of an example of the invention;

FIG. 8 is a schematic diagram of arrangement of liquid crystal molecules after a sealant curing step of an example of the invention;

FIG. 9 is an embodiment of forming a bulge on a color filter substrate of an example of the invention;

FIG. 10 is another embodiment of forming a bulge on a color filter substrate of an example of the invention; and

FIG. 11 is a flow diagram of processing steps in sequence contained in an example of the invention.

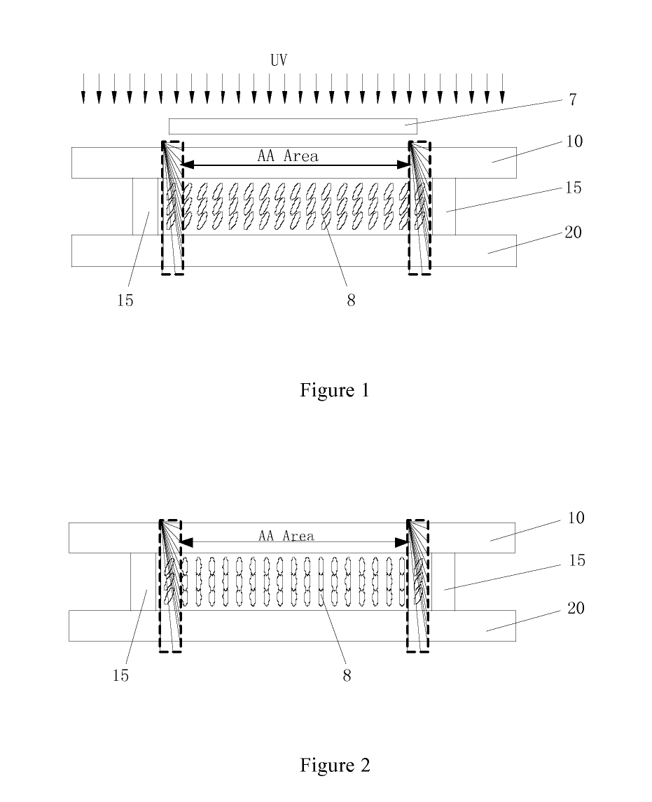

Legends: 10. color filter substrate; 20. array substrate; 21. pad; 11. conducting layer; 15. sealant; 7. UV mask; 8. LC molecule; 30. bulge; 31. first color photoresist material layer; 32. second color photoresist material layer; 33. third color photoresist material layer.

### DETAILED DESCRIPTION

The invention will further be described in detail in accordance with the figures and the preferable examples.

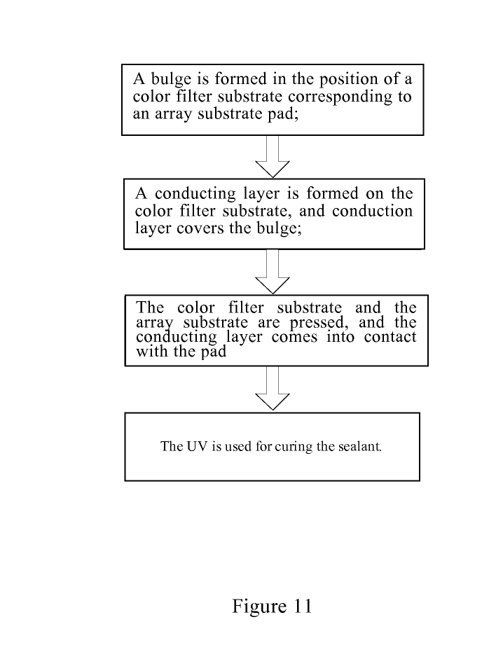

As shown in FIG. 11, a method for manufacturing the LCD panel of the invention comprises the following steps:

A: A bulge is formed in the position of a color filter substrate corresponding to an array substrate pad; B: A conducting layer is formed on the color filter substrate, and the conducting layer covers the bulge; C: The color filter substrate and the array substrate are pressed to make the conducting layer come into contact with the pad; D: The UV is used for curing the sealant; the manufacturing method also comprises subsequent PSVA manufacturing processes.

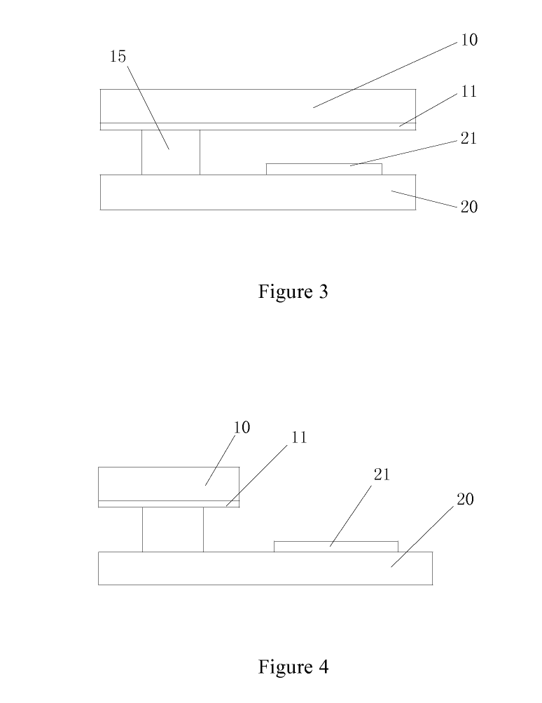

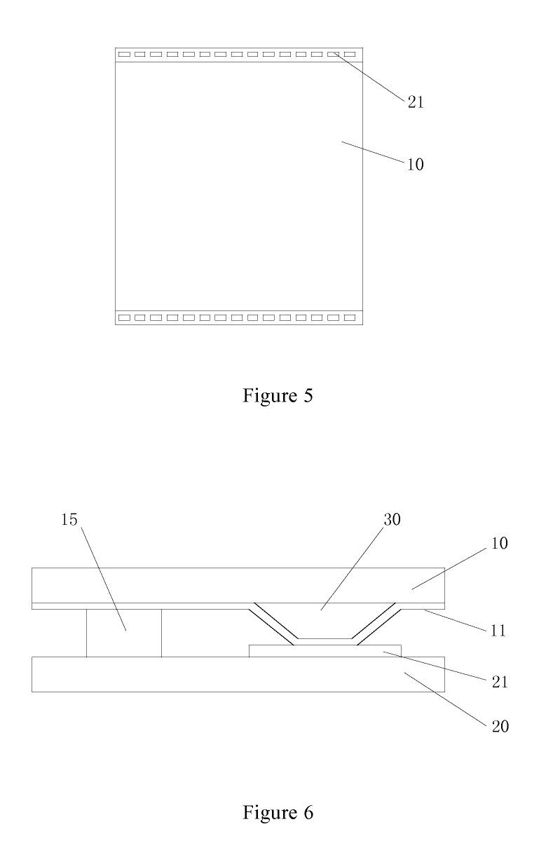

As shown in FIG. 3-5, a pad 21 is arranged outside the sealant 15 at the edge of the array substrate 20; prior to the PSVA manufacturing process of the LCD panel, the edge of the color filter substrate 10 shall be cut for exposing the pad 21 of the array substrate 20; thus, the voltage can be applied for performing a circuit test.

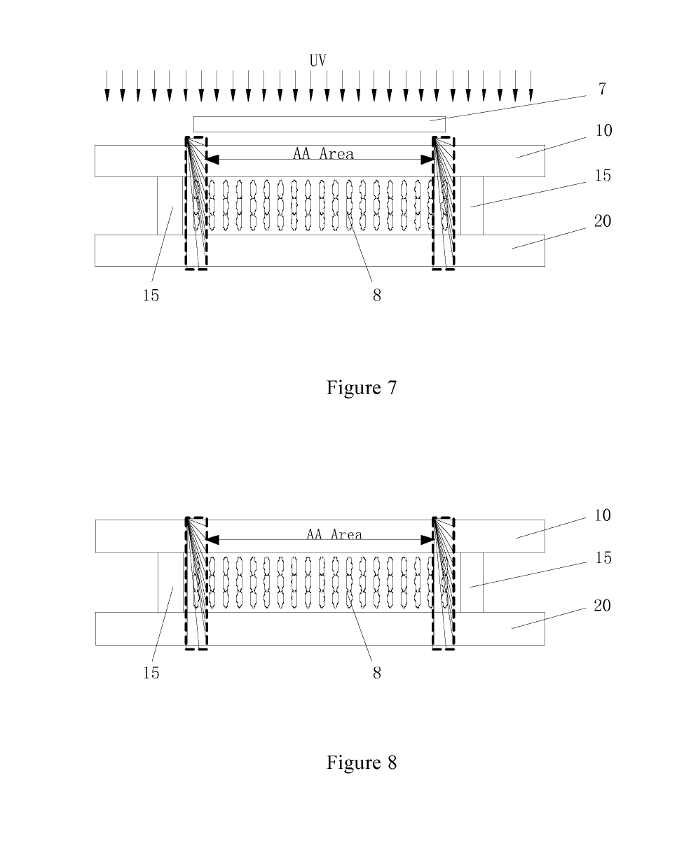

As shown in FIG. 6, before the edge of the color filter substrate 10 is cut, in the manufacturing technology of the color filter substrate 10, including the step A and the step B of the invention, namely, a bulge 30 is formed in the position of the edge to be cut of the color filter substrate corresponding to the array substrate pad 21, and the conducting layer covers the bulge 30 in the step of forming the conducting layer 11 of the color filter substrate 10. In the next step of pressing the color filter substrate 10 with the array substrate 20, including the step of the invention that the conducting layer 11 comes into contact with the pad 21, thus, the pressed conducting layer 11 on the color filter substrate 10 and the pad 21 on the array substrate 20 have the same potential; furthermore, the pad 21 is connected with a line on the array substrate 20, so that there is no potential difference between the color filter substrate 10 and the array substrate 20 which are opposite up and down. As shown in FIG. 7 and FIG. 8, in the step D of the invention, i.e. the step of curing the sealant by using the UV, because there is no potential difference between the color filter substrate 10 and the array substrate 20 which are opposite up and down, the liquid crystal molecules 8 at the edge of the LCD panel (the liquid crystal molecules 8 in the dotted frame in the figure) are not tilted to form a pre-tilt when irradiated by the UV, but are naturally vertical relative to the surface of the alignment layer (PI); thus, even if the periphery of the active area (AA area) is directly irradiated by the UV, resulting in the phenomenon of an nonuniform picture (mura), the phenomenon can be greatly improved; the distance between the boundary of the active area and the boundary of the UV can also be greatly shortened; in addition, the narrowing design of the LCD of the PSVA mode can also be easily realized.

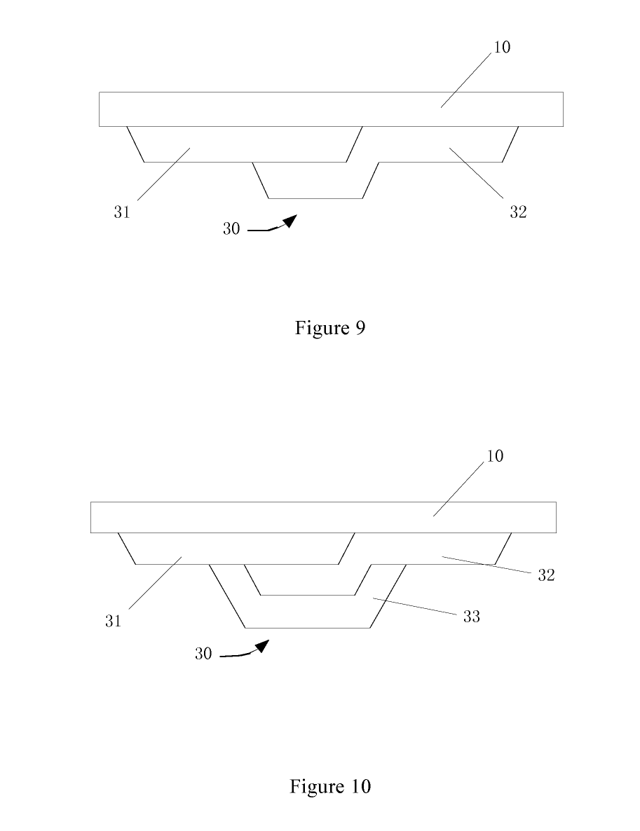

As shown in FIG. 9, in the step A of the invention, the technology of forming the bulge 30 on the color filter substrate 10 can be realized by forming stacked color photoresist material layers on the color filter substrate in the step of forming color resistance of the color filter substrate by using sequential steps of different color photoresist forming technologies; thus, the bulge 30 is formed. As shown in FIG. 9, in the embodiment provided by the invention, the first color photoresist material layer 31 is formed on the color filter substrate 10; when the second color photoresist material layer 32 is formed, the forming area of the second color photoresist material layer 32 coincides with the first color photoresist material layer 31 in the position of the bulge to be formed; thus, the bulge is formed. The first color photoresist material layer 31 and the second color photoresist material layer 32 can be respectively the red color photoresist material layer and the green color photoresist material layer, or the red color photoresist material layer and the blue color photoresist material layer, or the green color photoresist material layer and the blue color photoresist material layer.

As shown in FIG. 10, the invention can further provide another embodiment; the first color photoresist material layer 31 is formed on the color filter substrate 10; when the second color photoresist material layer 32 is formed, the forming area of the second color photoresist material layer 32 coincides with the first color photoresist material layer 31 in the position of the bulge to be formed; meanwhile, the third color photoresist material layer 33 is formed in the coincidence position; finally, the bulge 30 is formed; the first color photoresist material layer 31, the second color photoresist material layer 32 and the third color photoresist material layer 33 can be respectively the red color photoresist material layer, the green color photoresist material layer and the blue color photoresist material layer.

In addition, the manufacturing process and the sequence of forming the material layers on the color filter substrate are respectively: a black matrix, color photoresist materials (i.e. red, green and blue color photoresist materials) and an ITO layer. Thus, the material layers on the color filter substrate are not limited to the color photoresist materials; therefore, the bulge can be formed in the step of forming other material layers, or in the step of forming various types of material layers; for example, the bulge can be formed in the step of forming the black matrix material layer and the color photoresist material layers; or the black matrix, the color resistance and the PI layer coincide in the position corresponding to the pad in the step of simultaneously forming these material layers and the PI layer, so that the bulge can also be formed.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A method for manufacturing an LCD panel, comprising: the following steps:
A: When a color photoresist material layer is formed on a color filter substrate, a bulge is formed by forming a red color photoresist material layer, a green color photoresist material layer and a blue color photoresist material layer which are stacked in the position of the color filter substrate corresponding to an array substrate pad;
B: A conducting layer is formed on the color filter substrate, and the conducting layer covers said bulge;
C: The color filter substrate and the array substrate are pressed to make said conducting layer come into contact with said pad;
D: UV is used for curing a sealant.

2. A method for manufacturing an LCD panel, comprising: the following steps:
A: A bulge is formed in the position of a color filter substrate corresponding to an array substrate pad;
B: A conducting layer is formed on the color filter substrate, and the conducting layer covers said bulge;
C: The color filter substrate and the array substrate are pressed to make said conducting layer come into contact with said pad;
D: UV is used for curing a sealant.

3. The method for manufacturing the LCD panel of claim 2, wherein in said step A, said bulge formed on the color filter substrate is formed by forming the stacked color photoresist material layers in the position of the color filter substrate corresponding to the pad in the step of forming color resistance on said color filter substrate.

4. The method for manufacturing the LCD panel of claim 3, wherein in said step A, the stacked color photoresist material layers formed on the color filter substrate are formed by forming two color photoresist material layers in the position of said color filter substrate corresponding to said array substrate pad.

5. The method for manufacturing the LCD panel of claim 4, wherein said two color photoresist material layers are respectively a red color photoresist material layer and a green color photoresist material layer; or the two color photoresist material layers are respectively the red color photoresist material layer and a blue color photoresist material layer; or the two color photoresist material layers are respectively the green color photoresist material layer and the blue color photoresist material layer.

6. The method for manufacturing the LCD panel of claim 3, wherein in said step A, the stacked color photoresist material layers formed on the color filter substrate is formed by forming three color photoresist material layers in the position of the color filter substrate corresponding to said array substrate pad.

7. The method for manufacturing the LCD panel of claim 6, wherein said three color photoresist material layers are respectively the red color photoresist material layer, the green color photoresist material layer and the blue color photoresist material layer.

8. The method for manufacturing the LCD panel of claim 2, wherein in said step B, said conducting layer is an ITO material layer.

9. The method for manufacturing the LCD panel of claim 2, wherein in said step A, said bulge formed on the color filter substrate is formed by forming the stacked black matrix material layer and the color photoresist material layers in the position of said color filter substrate corresponding to the pad in the step of forming the color resistance and the black matrix on said color filter substrate.

10. A liquid crystal glass, comprising: an upper substrate and a lower substrate; wherein said lower substrate comprises a plurality of array substrate units; said upper substrate comprises a plurality of color filter substrate units corresponding to said array substrate units; each array substrate unit on said lower substrate is provided with a pad at the edge; wherein a bulge is arranged in the position of said color filter substrate units corresponding to said pad; said color filter substrate units are provided with a conducting layer; said conducting layer covers said bulge; the conducting layer on said bulge comes into contact with said pad.

11. The liquid crystal glass of claim 10, wherein said bulge is formed by stacked color photoresist material layers.

12. The liquid crystal glass of claim 11, wherein said bulge is formed by stacking two color photoresist material layers.

13. The liquid crystal glass of claim 12, wherein said two color photoresist material layers are respectively the red color photoresist material layer and the green color photoresist material layer; or the two color photoresist material layers are respectively the red color photoresist material layer and the blue color photoresist material layer; or the two color photoresist material layers are respectively the green color photoresist material layer and the blue color photoresist material layer.

14. The liquid crystal glass of claim 11, wherein said bulge is formed by stacking three color photoresist material layers.

15. The liquid crystal glass of claim 14, wherein said three color photoresist material layers are respectively the red color photoresist material layer, the green color photoresist material layer, and the blue color photoresist material layer.

16. The liquid crystal glass of claim 10, wherein said conducting layer is an TIO material layer.
